(19) United States
(12) Patent Application Publication
(10) Pub. No.: US 2015/0033160 A1
(43) Pub. Date: Jan. 29, 2015

(54) DISPLAY DEVICE AND METHOD FOR PROVIDING USER INTERFACE THEREOF

(71) Applicant: SAMSUNG ELECTRONICS CO., LTD., Suwon-si (KR)

(72) Inventors: Lin XIE, Nanjing (CN); Siquan YANG, Nanjing (CN)

(73) Assignee: SAMSUNG ELECTRONICS CO., LTD., Suwon-si (KR)

(21) Appl. No.: 14/331,325

(22) Filed: Jul. 15, 2014

(30) Foreign Application Priority Data
Jul. 26, 2013 (CN) 201310321521.2
Aug. 26, 2013 (KR) 10-2013-0101089

(51) Int. Cl. G06F 3/0481; G06F 3/0482; G06F 3/0484

(52) U.S. Cl. CPC G06F 3/04817; G06F 3/04842; G06F 3/0482
USPC 715/765; 715/835

(57) ABSTRACT

A display device and a method for providing the same are provided. The method includes displaying wallpaper and at least one icon, and providing a visual effect in which the wallpaper and the at least one icon are displayed in conjunction with each other according to a kind of wallpaper in response to a user command being input to the display device.

### CROSS-REFERENCE TO RELATED APPLICATIONS

This application claims priority from Chinese Patent Application No. 201310321521.2, filed on Jul. 26, 2013 in the Chinese Patent Office, and Korean Patent Application No. 10-2013-0101089, filed on Aug. 26, 2013 in the Korean Intellectual Property Office, the disclosures of which are incorporated herein by reference in their entirety.

### BACKGROUND

1. Field

Apparatuses and methods consistent with exemplary embodiments relate to a display device and a method for providing a user interface thereof, and more particularly, to a display device which displays wallpaper and at least one icon configured to execute an application or program and a method for providing a user interface thereof.

2. Description of the Related Art

In recent years, various display devices (for example, smart phones, tablet personal computer (PCs), and the like) have been designed to display at least one icon configured to execute an application or program on wallpaper to provide user-friendly environments to a user.

Such display devices generate at least one icon in a visual layer different from the wallpaper. Specifically, the display devices display the wallpaper in the lowermost visual layer, display the at least one icon in a next visual layer to the lowermost visual layer, and display the application or program in the uppermost visual layer.

Accordingly, when a user command related to the at least one icon is input, the display devices provide a visual effect for the icon to which the user command is input regardless of the wallpaper.

That is, the related art display devices provide boring user-friendly environments to the user since the display devices display icons regardless of the wallpaper.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a display device and a method for providing a user interface, which provide a visual effect in which a wallpaper and at least one icon are displayed in conjunction with each other according to a kind of wallpaper so as to provide an interactive user environment when a user command is input.

According to an aspect of an exemplary embodiment, there is provided a method of providing a user interface (UI) of an display device, the method including: displaying wallpaper and at least one icon; and providing a visual effect in which the wallpaper and the at least one icon are displayed in conjunction with each other according to a kind of the wallpaper in response to a user command being input to the display device.

The providing may include, when the user command to select one of the at least one icons is input, providing the visual effect for the selected icon in conjunction with the wallpaper according to the kind of wallpaper. The method may further include executing an application corresponding to the selected icon.

The providing may include, when the wallpaper is sand-related wallpaper, providing the visual effect in which the selected icon is displayed as being sucked into sand.

The providing may include, when the wallpaper is water-related wallpaper, providing the visual effect in which the selected icon is soaked by or disappears into water.

The providing may include, when the wallpaper is snow-related wallpaper, generating an image of a footprint in a snowy road at a location in which the selected icon is displayed, and providing the visual effect in which the selected icon is displayed as being positioned in the footprint.

The providing may include, when the user command for selecting and deleting one of the at least one icons is input, providing the visual effect for the selected icon in conjunction with the wallpaper according to the kind of wallpaper. The method may further include deleting the selected icon from a display screen.

The providing may include, when the user command for turning a page of the wallpaper is input, providing the visual effect in which an element of the wallpaper positioned at a location at which the user command is input is displayed in conjunction with the at least one icon according to the kind of wallpaper.

The displaying may include displaying the wallpaper and the at least one icon in the same visual layer.

The wallpaper may be dynamic wallpaper and the displaying may include displaying the at least one icon in conjunction with a motion of the dynamic wallpaper.

The displaying may include displaying an element moving in the dynamic wallpaper in a region other than a region in which the at least one icon is displayed.

The displaying may include displaying the at least one icon in conjunction with the wallpaper in a manner which is different from a manner of displaying remaining icons other than the at least one icon according to attribute of the at least one icon.

According to another aspect of an exemplary embodiment, there is provided a display apparatus including: a display configured to display wallpaper and at least one icon; an inputter configured to receive a user command as input; and a controller configured to control the display to provide a visual effect in which the wallpaper and the at least one icon are displayed in conjunction with each other according to a kind of wallpaper in response to the user command being input through the inputter.

The controller may, when the user command to select one of the at least one icons is input through the inputter, control the display to provide the visual effect for the selected icon in conjunction with the wallpaper according to the kind of wallpaper and execute an application corresponding to the selected icon.

The display may be configured to display sand-related wallpaper as the wallpaper and the controller may be configured to control the display to provide the visual effect in which the selected icon is displayed as being sucked into the sand.

The display may be configured to display water-related wallpaper as the wallpaper and the controller may be configured to control the display to provide the visual effect in which the selected icon is displayed as disappearing into the water.

The display may be configured to display snow-related wallpaper as the wallpaper and the controller may be configured to generate an image of a footprint in a snowy road at a location in which the selected icon is displayed, and control the display to provide the visual effect in which the selected icon is positioned in the footprint.

The controller may, when the user command to select and delete one of the at least one icons is input through the inputter, be configured to control the display to provide the visual effect for the selected icon in conjunction with the wallpaper according to the kind of wallpaper and may be further configured to delete the selected icon from a screen of the display.

The controller may, when the user command for turning a page of the wallpaper is input through the inputter, be configured to control the display to provide the visual effect in which an element of the wallpaper positioned at a location at which the user command is input is displayed in conjunction with the at least one icon according to the kind of wallpaper.

The display may be configured to display the wallpaper and the at least one icon in the same visual layer.

The wallpaper may be dynamic wallpaper and the controller may be configured to control the display to display the at least one icon in conjunction with a motion of the dynamic wallpaper.

The controller may be configured to control the display so that an element which is displayed as moving in the dynamic wallpaper moves in a region other than a region in which the at least one icon is displayed.

The controller may be configured to control the display so that the at least one icon is displayed in conjunction with the wallpaper in a manner which is different from a manner of displaying the remaining icons other than the at least one icon according to attribute of the at least one icon.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and/or other aspects will be more apparent by describing in detail exemplary embodiments, with reference to the accompanying drawings, in which:

FIG. 1 is a block diagram schematically illustrating a configuration of a display device according to an exemplary embodiment;

FIG. 2 is a block diagram illustrating a configuration of the display device according to an exemplary embodiment;

FIG. 3 is a block diagram illustrating a configuration of a controller according to an exemplary embodiment;

FIG. 4 is a view illustrating a hierarchy of software stored in a display device according to an exemplary embodiment;

FIGS. 5A, 5B, 5C, 6A, 6B, 7A, 7B, 8A, 8B, 9A, 9B, 9C, 10A, 10B, 11A, 11B, 12A, 12B, 13A, 13B, 14A, 14B, 15A, 15B, 16A, 16B, 16C, 17 and 18 are views illustrating examples in which an icon and a wallpaper are displayed in conjunction with each other; and

FIG. 19 is a flowchart illustrating a method for providing a user interface of a display device according to an exemplary embodiment.

### DETAILED DESCRIPTION OF THE EXEMPLARY EMBODIMENTS

Hereinafter, exemplary embodiments will be described in more detail with reference to the accompanying drawings.

In the following description, the same reference numerals are used for the same elements when the reference numerals are depicted in different drawings. The matters defined in the description, such as a detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

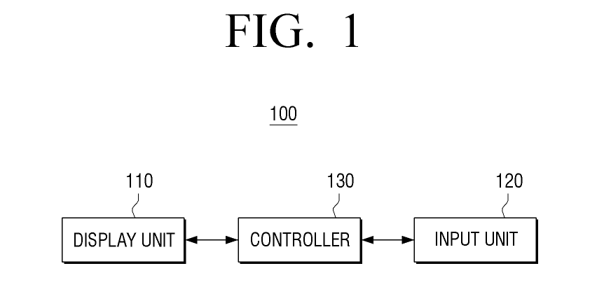

FIG. 1 is a block diagram schematically illustrating a configuration of a display device 100 according to an exemplary embodiment. Referring to FIG. 1, the display device 100 includes a display unit 110 (e.g., display), an input unit 120 (e.g., inputter), and a controller 130. The display device 100 may be implemented as a smart phone, although this is simply an example. Alternatively, the display device 100 may be implemented as a table PC, a desktop PC, a laptop PC, a smart television (TV), and the like.

The display unit 110 outputs image data under control of the controller 130. In particular, the display unit 110 may display wallpaper and at least one icon configured to execute a program or application. At this time, the display unit 110 may display the wallpaper and the at least one icon in one visual layer.

The display unit 110 may display dynamic wallpaper. The dynamic wallpaper may be wallpaper in which an element in the wallpaper moves. As an example, the dynamic wallpaper may include a fish-moving wallpaper, a snowing wallpaper, and the like.

The input unit 120 receives a user command for controlling the display device 100. Specifically, the input unit 120 may receive user commands for selecting, deleting, or moving an icon displayed in the display unit 110. The input unit 110 may receive the user command for turning a page of the wallpaper.

The input unit 120 according to an exemplary embodiment may be implemented with a touch screen, a button, and the like, but these are simply examples. The input unit 120 may be implemented as a mouse, a keyboard, a pointing device, a motion recognizer, a voice recognizer, and the like.

The controller 130 controls an overall operation of the display device 100 according to the user command input to the input unit 120. In particular, when the preset user command is input through the input unit 120, the controller 130 controls the display unit 110 to provide a visual effect in which the wallpaper and at least one icon are displayed in conjunction with each other according to a kind of wallpaper.

Specifically, when the user command (for example, an operation of tapping an icon displayed on a touch screen) for selecting the one of the at least one icons is input through the input unit 120, the controller 130 may control the display unit 110 to provide the visual effect for the selected icon in conjunction with (e.g., interacting with) the wallpaper according to the kind of wallpaper. For example, when the display unit 110 displays a sand-related wallpaper, if the user command for selecting one of the at least one icons is input through the user input 120, the controller 130 may control the display unit 110 to provide the visual effect in which the selected icon is sucked in the sand on the wallpaper. As another example, when the display unit 110 displays a water-related wallpaper, if the user command for selecting the one of the at least one icons is input through the input unit 120, the controller 130 may control the display unit 110 to provide the visual effect in which the selected icon disappears into the water. As yet another example, when the display unit 110 displays a snow-related wallpaper, if the user command for selecting the one of the at least one icons is input through the input unit 120, the controller 130 may control the display unit 110 to generate a footprint in a snowy road at a location in which the selected icon is displayed and provide the visual effect in which the selected icon is inside of the foot print. Many different other types of visual effects are possible according to exemplary embodiments.

The controller 130 may execute an application or program corresponding to the selected icon and control the display unit 110 to display an execution screen.

Further, when the user command (for example, an operation of holding an icon displayed on a touch screen for a preset period of time) for deleting one of the at least one icons is input through the input unit 120, the controller 130 may control the display unit 110 to provide the visual effect for the selected icon in conjunction with the wallpaper according to the kind of wallpaper and delete the selected icon from the display screen. For example, when the display unit 110 displays a wafer-related wallpaper, if the user command for deleting the one of the at least one icons is input through the input unit 120, the controller 130 may control the display unit 110 to display the visual effect in which the selected icon gradually disappears into the water and thus the selected icon is deleted.

When the user command (for example, an operation of flicking wallpaper of a touch screen) for turning a page of the wallpaper is input through the input unit 120, the controller 130 may control the display unit 110 to provide the visual effect in which an element of the wallpaper existing at a location at which the user command is input and the at least one icon are displayed in conjunction with each other according to the kind of wallpaper. For example, when the display unit 110 displays a snow-related wallpaper, if the user command for turning a page of the wallpaper is input, the controller 130 may control the display unit 110 to provide the visual effect in which snow is displayed as being sprinkled on the at least one icon at a point at which touch of the user is input is likely.

When the display unit 110 displays dynamic wallpaper, the controller 130 may control the display unit 110 to display the at least one icon in conjunction with a motion of the dynamic wallpaper. For example, when dynamic wallpaper related to a lake in which the waves are rising is displayed, the controller 130 may control the display unit 110 to display the at least one icon so that the at least one icon moves along with the motion of the waves.

As another example, when the display unit 110 displays dynamic wallpaper, the controller 130 may control the display unit 110 so that an element moving in the dynamic wallpaper moves in a remaining region other than a region in which at least one icon is displayed. For example, when the display unit 110 displays the dynamic wallpaper in which a fish moves, the controller 130 may control the display unit 110 so that the fish moves in the remaining region other than the region in which the at least one icon is displayed and the fish does not overlap the at least one icon.

The controller 130 may control the display unit 110 to display the at least one icon in conjunction with the wallpaper differently from remaining icons of the icons according to an attribute of the at least one icon. For example, the attribute of the at least one icon may include a program loading state corresponding to a corresponding icon, a frequency of use of the icon, and the like. For example, when sand-related wallpaper is displayed, the controller 130 may control the display unit to display the icons to be in different depths in the sand according to the frequency of use of the icons. For example, for an icon which is not frequently used, the controller 130 may more deeply display the icon in the sand related to other icons.

Through the above-described display device 100, the user may experience a more interactive user environment.

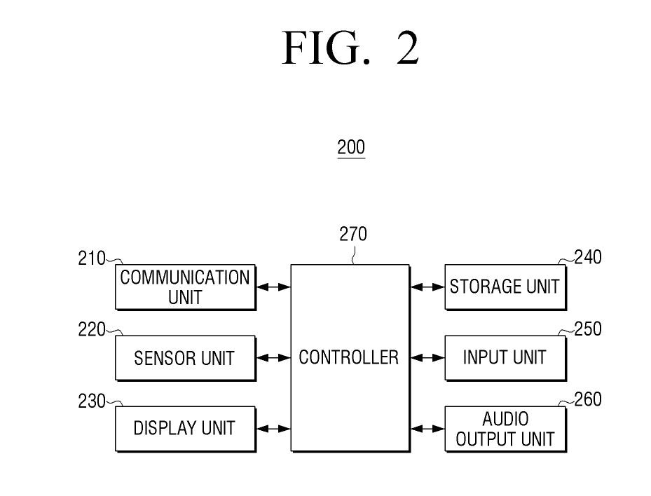

Hereinafter, a display device 200 will be described in more detail with reference to FIGS. 2 to 18. FIG. 2 is a block diagram specifically illustrating a configuration of the display device 200 according to an exemplary embodiment. As illustrated in FIG. 2, the display device 200 includes a communication unit 210, a sensor unit 220, a display unit 230, a storage unit 240, an input unit 250, an audio output unit 260, and the controller 270.

FIG. 2 exemplifies a device which includes various functions such as a communication function, a moving image reproducing function, a display function, and the like as the display device 200 and integrally illustrates various kinds of components. In some exemplary embodiments, a portion of the components illustrated in FIG. 2 may be omitted or modified and other components may be added.

The communication unit 210 is configured to perform communication with various types of external apparatuses according to various communication methods. In particular, the communication unit 210 may include various communication modules such as a broadcast reception module, a mobile communication module, a global positioning system (GPS) module, and a wireless communication module. According to an exemplary embodiment, the broadcast reception module may include a terrestrial broadcasting reception module (not shown) configured to receive a terrestrial broadcast signal and include an antenna, a demodulator, an equalizer, and the like, a digital multimedia broadcasting (DMB) module configured to receive and process a DMB broadcast signal, and the like. When the display device is implemented as a mobile device having a broadcast reception function such as a portable phone, the broadcasting reception module may be necessary. The mobile communication module is a module configured to access a mobile communication network and perform communication according to various mobile communication standards such as 3rd generation (3G), 3rd generation partnership project (3GPP), or long term evolution (LTE). The GPS module is a module configured to receive a GPS signal from a GPS satellite and detect a current position of the display device 200. The wireless communication module is a module configured to be connected to an external network and perform communication according to a wireless communication protocol such as wireless fidelity (Wi-Fi) or an institute of electrical and electronic engineers (IEEE) standard. In particular, the controller 270 may perform communication with external apparatuses using the mobile communication module or the wireless communication module.

The sensor unit 220 (e.g., sensor) senses a motion, state, and the like of the display device 200 according to actions of the user using the display device 200. In particular, the sensor unit 220 may include various types of sensors such a geomagnetic sensor or an acceleration sensor. The geomagnetic sensor is a sensor configured to sense a rotation state and a moving direction of the display device 200 and the acceleration sensor is a sensor configured to sense a tilting degree of the display device 200. Therefore, the controller 270 may recognize the motion of the user using output values sensed in the geomagnetic sensor and the acceleration sensor to determine a shaking state of the display device, a tilting direction of the display device, and the like.

The display unit 230 includes a display panel, a backlight unit, and the like. The display unit 230 displays an information input screen for various pieces of information, an information display screen, and the like. In particle, the display unit 230 may display wallpaper and at least one icon for executing a program or application.

At this time, the wallpaper may be static wallpaper, but this is simply an example. The wallpaper may alternatively be dynamic wallpaper in which elements move. In particular, when the wallpaper is the dynamic wallpaper, the display unit 230 may display the at least one icon in conjunction with the motion of the dynamic wallpaper.

The storage unit 240 may store various programs or data related to operations of the display devices 200, setting information set by the user, operating software, various kinds of application programs, information for operations corresponding to user operation contents, and the like.

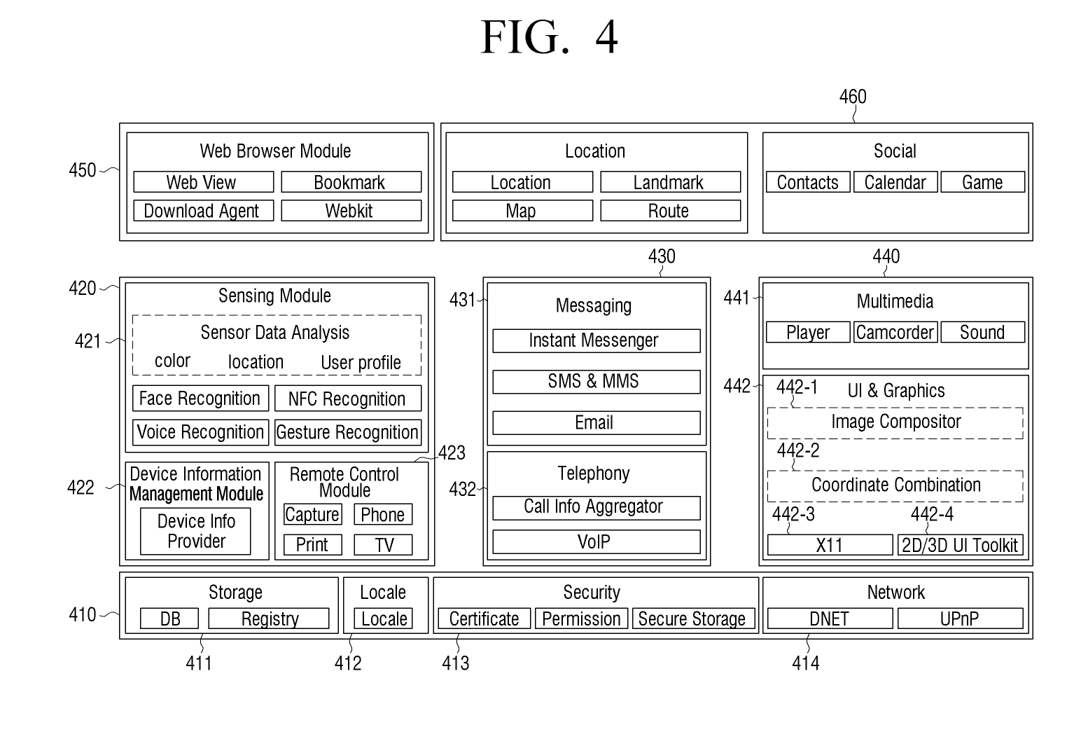

In particular, the storage unit 240 includes a software structure as illustrated in FIG. 4 to support an operation of the controller 270. Referring to FIG. 4, the storage unit 240 includes a base module 410, a device management module 420, a communication module 430, a presentation module, 440, a web browser module 450, and a service module 460.

The base module 410 is a basic module configured to process a signal transferred from hardware included in the display device 200 and transfer the processed signal to an upper layer module.

The base module 410 includes a storage module 411, a location-based module 412, a security module 413, and a network module 414.

The storage module 411 is a program module configured to manage a data base (DB) or a registry. The location-based module 412 is a program module configured to support location-based services in conjunction with hardware such as a GPS chip. The security module 413 is a program module configured to support certification for hardware, permission, secure storage, and the like. The network module 414 is a module configured to perform a network connection and includes a device net (DNET) module, a universal plug and play (UPnP) module, and the like.

The device management module 420 is a module configured to manage information for an external input and an external device and use the information. The device management module 420 may include a sensing module 421, a device information management module 422, a remote control module 423, and the like.

The sensing module 421 is a module configured to analyze sensor data provided from the various types of sensors in the sensor unit 220. The sensing module 421 may include a face recognition module, a voice recognition module, a gesture recognition module, a near field communication (NFC) recognition module, and the like. The device information management module 422 is a module configured to provide information for various types of devices and the remote control module 423 is a program module configured to perform a remote control operation on peripheral devices such as phones, TVs, printers, cameras and air conditioners.

The communication module 430 is a module configured to perform communication with the outside. The communication module 430 may include a messaging module 431 such a messenger program, a short message service (SMS) & multimedia message service (MMS) program or an e-mail program, and may further include a phone module 432 including a call information aggregator program module, a voice over Internet protocol (VoIP) module, and the like.

The presentation module 440 is a module configured to configure a display screen. The presentation module 440 includes a multimedia module 441 configured to reproduce multimedia contents and output the reproduced multimedia contents and a user interface (UI) and graphic module 442 configured to perform UI and graphic processing. The multimedia module 441 may include a player module, a camcorder module, a sound processing module, and the like. According to this configuration, the multimedia module 441 performs an operation of generating various types of multimedia contents and generating and reproducing a screen and sound. The UI and graphic module 442 may include an image compositor module 442-1 configured to compose an image, a coordinate combination module 442-2 configured to combine and generate a coordinate on a screen on which an image is to be displayed, an X11 module 442-3 configured to receive various events from the hardware, and a 3D/3D UI toolkit 442-4 configured to provide a tool for configuring a 2-dimensional (2D) or 3-dimensional (3D) type UI.

The web browser module 450 is a module configured to perform web browsing to access a web server. The web browser module 450 may include various modules such as a web view module configured to configure a web page, a download agent module configured to perform a download, a book mark module, or a webkit module.

Further, the service module 460 is an application module configured to provide various services. For example, the service module 460 may include various modules such as a navigation service module configured to provide a map, current position, a landmark, path information, a game module, or an advertisement application module.

A main central processing unit (CPU) 272 in the controller 270 may access the storage unit 240 through a storage interface 276, copy various modules stored in the storage unit 240 to a random access memory (RAM) 271-2, and perform an operation corresponding to operations of the copied modules.

The software structure as illustrated in FIG. 4 is merely one exemplary embodiment and it is understood that other exemplary embodiments may be implemented to include other software structures.

The input unit 250 receives a user command for controlling the display device 200. Specifically, the input unit 250 may receive user commands for selecting, deleting, and moving an icon displayed in the display unit 230 and a user command for turning a page of wallpaper.

In particular, the input unit 250 according to an exemplary embodiment may be implemented as a touch panel. The touch panel may be implemented as a capacitive touch sensor or a resistive touch sensor. According to an exemplary embodiment, the touch panel is built in the display unit 230, senses a touch, and transfers a sensing result to the controller 270 when the user touches a surface of the display unit 230. The controller 270 calculates a coordinate of the touched point to determine whether or not a particular icon is selected on the screen.

However, it is merely exemplary that the input unit 250 is implemented as a touch panel, and the input unit 250 may be alternatively implemented as various other types of input devices such as a mouse, a keyboard, a pointing device, a motion input unit, or a voice input unit.

The audio output unit 260 is configured to output various audio data processed in an audio processor 275, as well as various alarm sounds or voice messages.

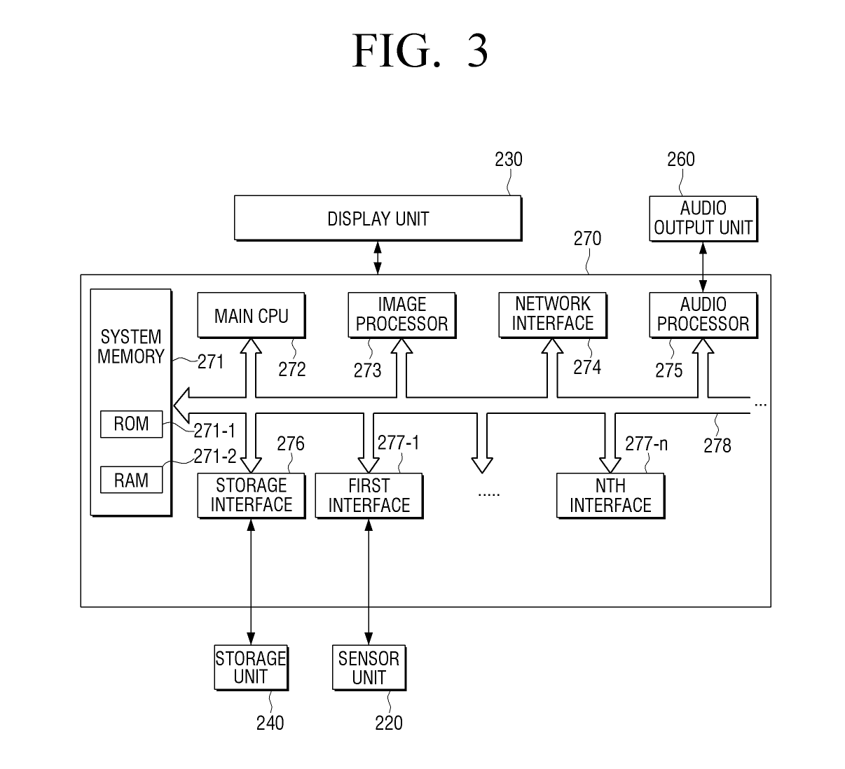

The controller 270 may selectively activate the respective components according to a user command input through the input unit 250 and perform various operations. FIG. 3 is a view illustrating a detailed configuration of the controller 270.

Referring to FIG. 3, the controller 270 includes a system memory 271, the main CPU 272, an image processor 273, a network interface 274, the audio processor 275, the storage interface 276, first to nth interfaces 277-1 to 277-n, and a system bus 278.

The system memory 271, the main CPU 272, the image processor 273, the network interface 274, the audio processor 275, the storage interface 276, and the first to nth interfaces 277-1 to 277-n may be connected to each other through the system bus 278 and may transmit and receive various data signals.

The first to nth interfaces 277-1 to 277-n support interfacing between various components including the sensor unit 220 and the respective components in the controller 270.

Although FIG. 3 illustrates that the sensor unit 220 is connected to the controller 270 only through the first interface 277-1, when the sensor unit 220 includes various types of sensors or a plurality of sensors, each of the sensors may be connected through a different respective interface. Further, at least one of the first to nth interfaces 277-1 to 277-n may be implemented as an input interface configured to receive various signals from a button provided in a body portion of the display device 200 or an external apparatus connected through an external input port 1 to an external input port n.

The system memory 271 includes a read only memory (ROM) 271-1 and the RAM 271-2. The ROM 271-1 stores a command set for system booting. When a turn-on command is input and power is supplied, the main CPU 272 copies an operating system (OS) stored in the storage unit 240 to the RAM 271-2 according to a command stored in the ROM 271-1 and executes the OS to boot the system. When the booting is completed, the main CPU 272 copies various application programs stored in the storage unit 240 to the RAM 271-2 and executes the application programs copied in the RAM 271-2 to perform various operations.

The main CPU 272 may execute application programs stored in the storage unit 240, receive data from external objects, and process the received data to generate behavior information. In particular, when the wallpaper and the at least one icon are displayed in the display unit 230, if the preset user command is input through the input unit 250, the main CPU 272 may control the wallpaper and the at least one icon to be displayed in conjunction with each other according to a kind of wallpaper to provide a visual effect.

The storage interface 276 is connected to the storage unit 240 to receive and transmit various programs, contents, data, and the like.

The image processor 273 may include a decoder, a renderer, a scaler, and the like. Therefore, the image processor 273 may decode image data received from external apparatuses, perform rendering on the decoded data to form a frame, and perform scaling on a size of the formed frame to scale the formed frame to be suitable for a screen size of the display unit 230. The image processor 273 provides the processed frame to the display unit 230 to be displayed.

In particular, the image processor 273 may process the wallpaper and the at least one icon to be disposed in the same visual layer. Specifically, the image processor 273 may process the wallpaper and the at least one icon to be disposed in the same visual layer using various types of programs such as Canvas and Surfaceview, OpenGL ES and NDK, or RenderScript.

Further, the audio processor 275 is configured to process audio data and to provide the processed audio data to a sound output unit such as the audio output unit 260. The audio processor 275 reads various alarm sound data from the storage unit 240 and generates an alarm sound signal using the read data. The generated alarm sound signal may be provided to the audio output unit 260 to be output. Further, various pieces of information such as basic information, behavior information, or health care information may be generated as an audio signal and then output through the audio output unit 260.

The network interface 274 is a component connected to an external apparatus through a network. For example, the main CPU 272 may access a web server through the network interface 274 when the web browser program is executed. When web page data is received from the web server, the main CPU 272 controls the image processor 273 to form a web page screen and displays the formed web page screen on the display unit 230.

As described above, the various operations of the controller 270 may be implemented through execution of various programs stored in the storage unit 240.

FIG. 3 illustrates the configuration of the controller 270 configured to perform operations according to one of the various exemplary embodiments, but in some other exemplary embodiments, some components in the configuration of the controller 270 may be omitted or modified and other components may be added to the configuration of the controller 270.

The controller 270 may process the wallpaper and the at least one icon as one visual layer (e.g., a single visual layer). The controller 270 may control the display unit 230 to display the wallpaper and the at least one icon through one visual layer.

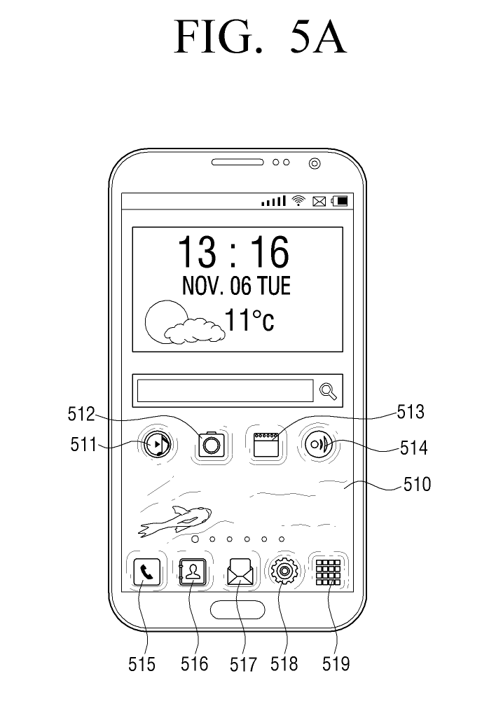

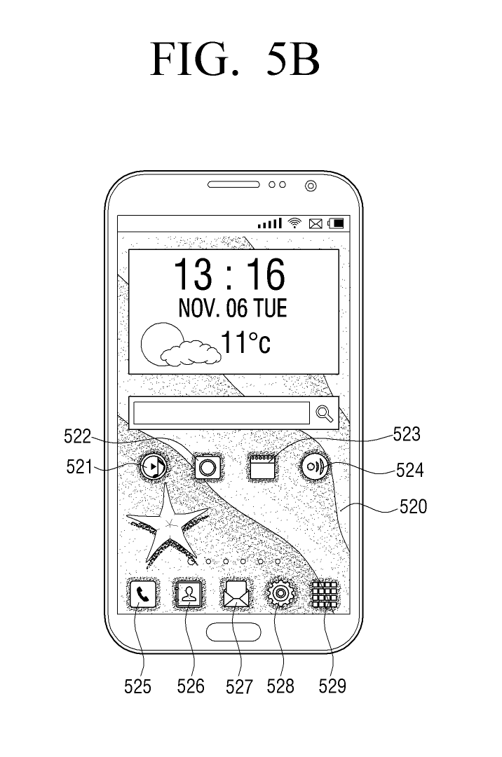

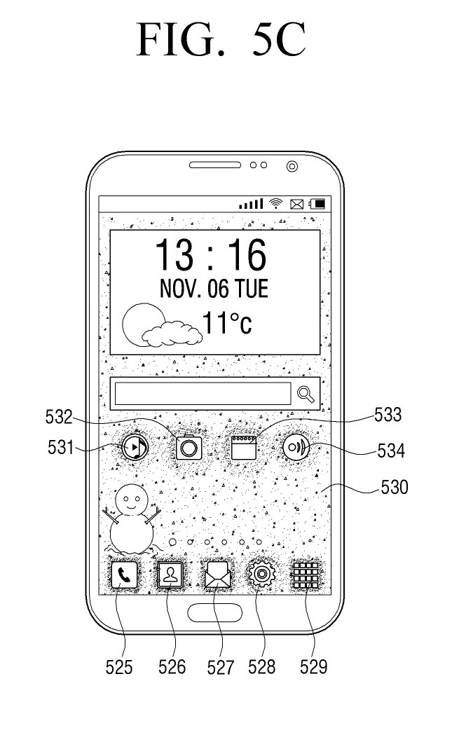

The controller 270 may process the wallpaper and the at least one icon so that the at least one icon is included in the wallpaper. For example, as illustrated in FIG. 5A, when a water-related wallpaper 510 is displayed, the controller 270 may control the display unit 230 to display the wallpaper and the icon such that first to ninth icons 511 to 519 are floating in the water of the wallpaper 510. As illustrated in FIG. 5B, when a sand-related desert wallpaper 520 is displayed, the controller 270 may control the display unit 230 to display the wallpaper and the icon such that first to ninth icons 521 to 529 are appear to be buried in the sand of the desert wallpaper 520. As illustrated in FIG. 5C, when a snow-related wallpaper 530 is displayed, the controller 270 may control the display 230 to display the wallpaper and the icon such that first to ninth icons 531 to 539 are buried in the snow of the wallpaper 530.

According to an exemplary embodiment, the wallpaper may be dynamic wallpaper in which elements included in the wallpaper move. When the wallpaper is dynamic wallpaper, the controller 270 may control the display unit 230 so that at least one icon moves along with motions of the elements of the wallpaper. For example, when the display unit 230 displays wallpaper in which waves are rolling, the controller 270 may control the display unit 230 to shake at least one icon along with the rolling waves. When the display unit 230 displays dynamic wallpaper in which sand is blown, the controller 270 may control the display unit 230 to repeatedly perform an operation in which at least one icon is covered by the sand and then reappears. When the display unit 230 displays a snowing dynamic wallpaper, the controller 270 may control the display unit 230 to repeatedly perform an operation in which at least one icon is covered in the snow and then reappears.

While a wallpaper and at least one icon are displayed in the display unit 230, if a user command for selecting one of the at least one icons is input, the controller 270 may control the display unit 230 to provide a visual effect for the selected icon in conjunction with the wallpaper according to a kind of wallpaper and execute an application or program corresponding to the selected icon.

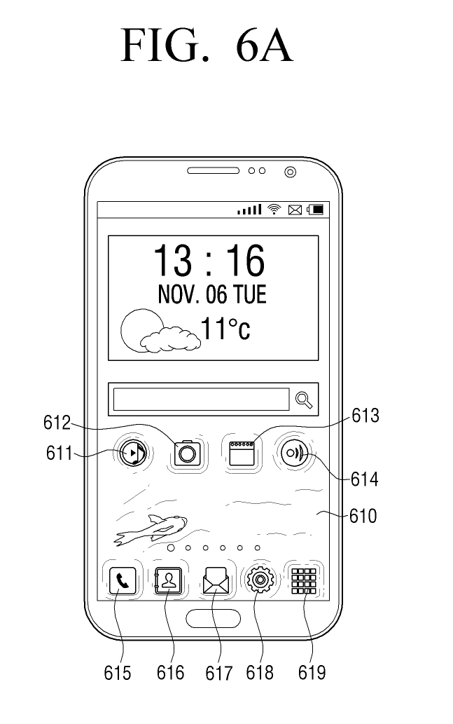

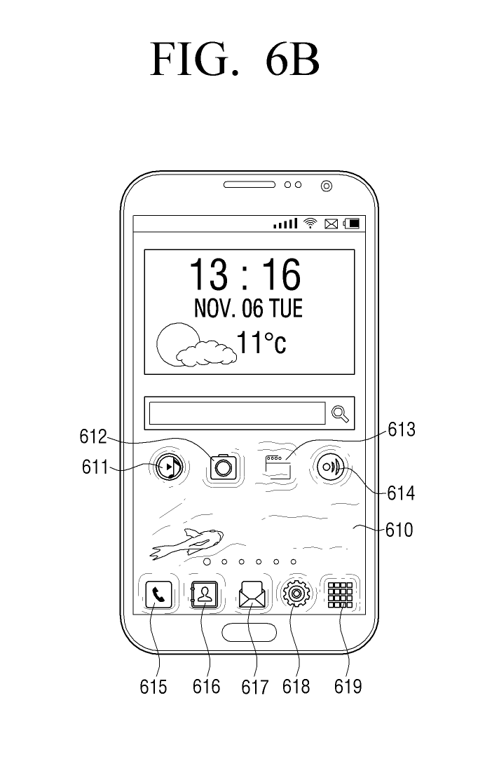

Specifically, for example, when a water-related wallpaper 610 is displayed as illustrated in FIG. 6A, if a user command (for example, an operation of tapping a third icon 613 on a touch screen) for selecting the third icon 613 among first to ninth icons 611 to 619 is input, as illustrated in FIG. 6B, the controller 270 may control the display unit 230 to provide a visual effect displaying the selected third icon 613 as being soaked into or disappearing in the water. Further, the controller 270 may control the display unit 230 to execute a calendar application corresponding to the third icon 613 and to display an application execution screen before the third icon 613 is soaked into or disappears in the water.

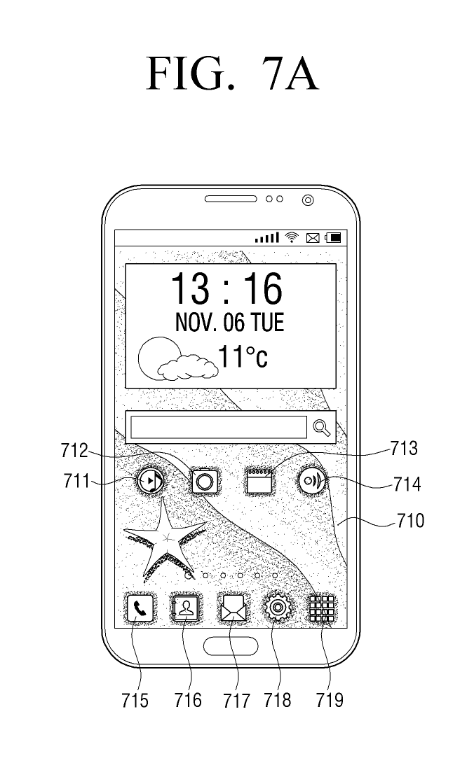

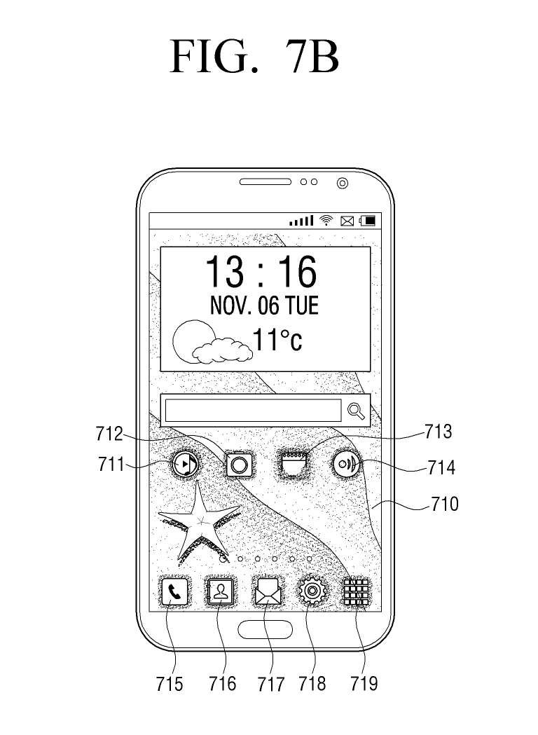

As another example, when a sand-related desert wallpaper 710 is displayed as illustrated in FIG. 7A, if a user command (for example, an operation of tapping a third icon 713 on a touch screen) for selecting the third icon 713 among first to ninth icons 711 to 719 is input, as illustrated in FIG. 7B, the controller 270 may control the display unit 230 to provide a visual effect in which the selected third icon 713 is soaked into or disappears in the sand. Further, the controller 270 may control the display unit 230 to execute a calendar application corresponding to the third icon 713 and to display an application execution screen before the third icon 713 is soaked into or disappears in the sand.

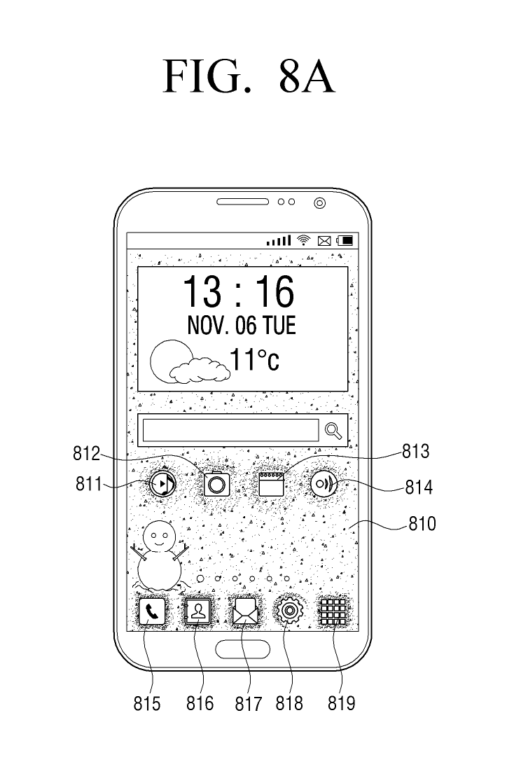

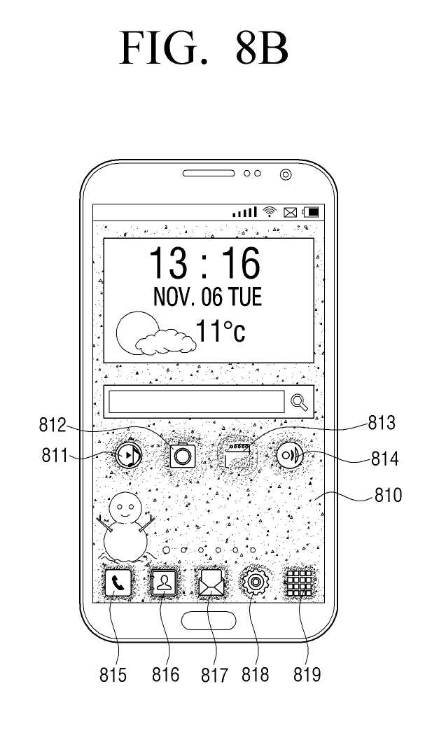

As another example, when a snow-related wallpaper 810 is displayed as illustrated in FIG. 8A, if a user command (for example, an operation of tapping a third icon 813 on a touch screen) for selecting the third icon 813 among first to ninth icons 811 to 819 is input, as illustrated in FIG. 8B, the controller 270 may control the display unit 230 to generate a visual effect of a footprint in a snowy road at a location in which the third icon 813 is displayed and provide a visual effect in which the selected third icon 813 is moved into the footprint. That is, the controller 270 may control the display unit 230 to provide the visual effect in which the selected icon walks down the snowy road. Further, the controller 270 may control the display unit 230 to execute a calendar application corresponding to the third icon 813 and to display an application execution screen.

When a user command for deleting one of at least one of the icons is input when a wallpaper and the at least one icon are displayed by the display unit 230, the controller 270 may control the display unit 230 to provide a visual effect for the selected icon in conjunction with the wallpaper according to a kind of wallpaper and to delete the selected icon from the displayed screen.

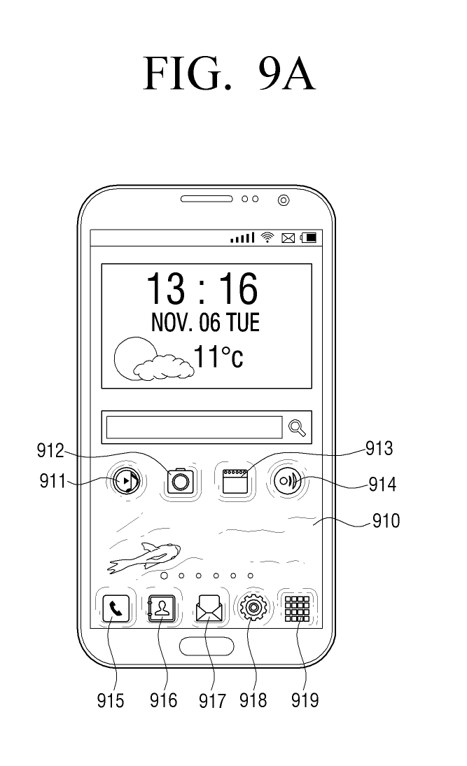

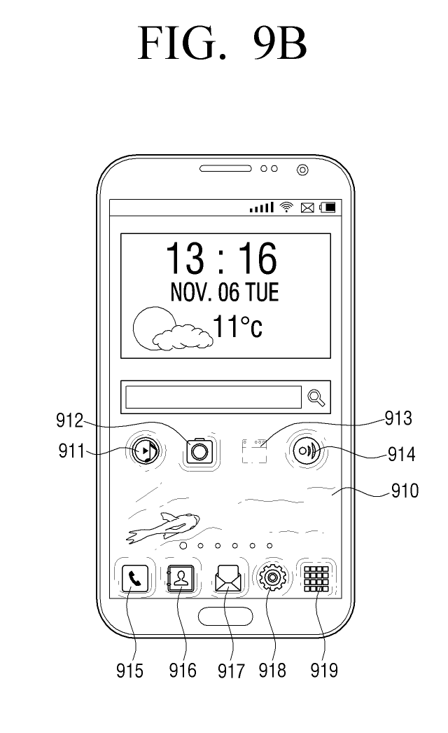

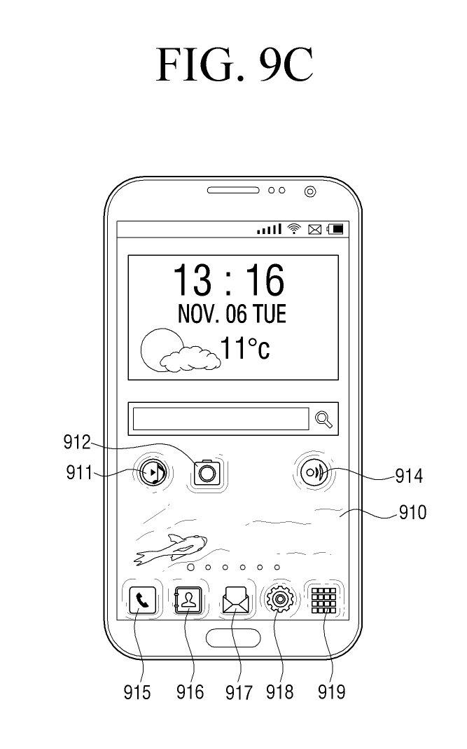

Specifically, for example, when first to ninth icons 911 to 919 are displayed in water-related wallpaper 910 as illustrated in FIG. 9A, if a user command (for example, an operation for holding a third icon 913 displayed on a touch screen for a preset period of time) for deleting the third icon 913 is input, the controller 270 may control the display unit 230 to provide a visual effect in which the selected third icon 913 gradually disappears in the water as illustrated in FIG. 9B and the controller may control the display unit 230 to delete the third icon 913 from the display screen as illustrated in FIG. 9C after the preset period of time elapses.

Of course, the visual effect which is displayed according to the icon deletion command in the water-related wallpaper 910, as illustrated in FIGS. 9A to 9C, is merely exemplary and another visual effect may be provided in conjunction with other wallpapers. For example, a visual effect may be provided in which the icon to be deleted according to the icon deletion command gradually disappears in the sand and completely disappears from the display screen in the sand-related desert wallpaper. In another example, a visual effect may be provided in which the icon to be deleted according to the icon deletion command gradually disappears in the snow and completely disappears from the display screen in the snow-related wallpaper.

When a user command for turning a page of wallpaper is input when the wallpaper and the at least one icon are displayed in the display unit 230, the controller 270 may control the display unit 230 to provide a visual effect for an element of the wallpaper, which is displayed at a location at which the user command is input, in conjunction with the at least one icon according to a kind of wallpaper.

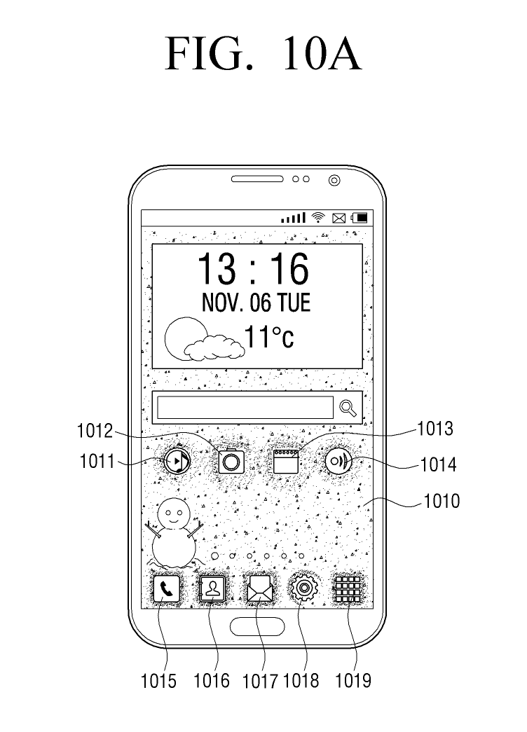

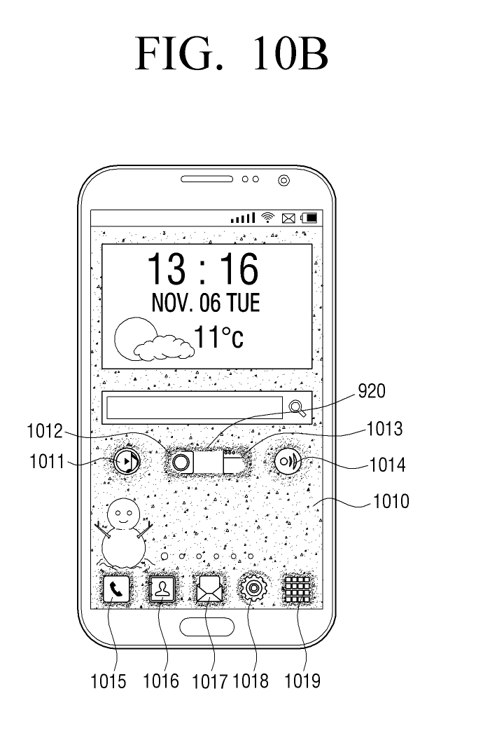

Specifically, for example, when a user command (for example, an operation of flicking away from a region in which a second icon 1012 is displayed to a region in which a third region 1013 is displayed) for turning a page of the wallpaper is input when the snow-related wallpaper 1010 is displayed as illustrated in FIG. 10A, the controller 270 may control the display unit 230 to provide a visual effect such that the snow in the region to which the user command is input (for example, between the regions corresponding to the second icon 1012 and the third icon 2013) is cleared away and the snow is sprinkled onto the second icon 1012 and the third icon 1013.

The visual effect provided according to the page turning command in the snow-related wallpaper 1010, as illustrated in FIGS. 10A and 10B, is merely exemplary and another visual effect may be provided to other wallpapers. For example, a visual effect may be provided in which the icon located around the region to which the page turning command is input sways along with a wave in the water-related wallpaper. As yet another example, a visual effect may be provided in which the sand of the region at which the page turning command is input splatters on neighboring icons in the sand-related wallpaper.

When a user shakes the display device 200 when a wallpaper and at least one icon are displayed in the display unit 230, the controller 270 may sense a user command indicating the shaking of the display device 200 through the sensor unit 220 and control the display unit 230 to provide a visual effect for the at least one icon in conjunction with the wallpaper according to a kind of wallpaper.

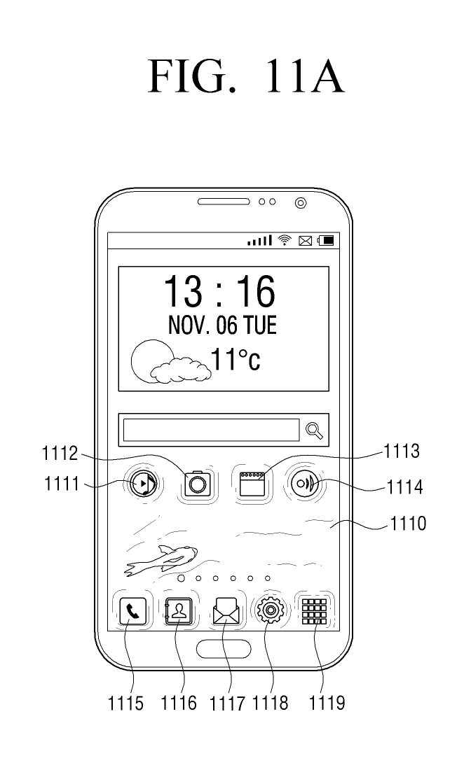

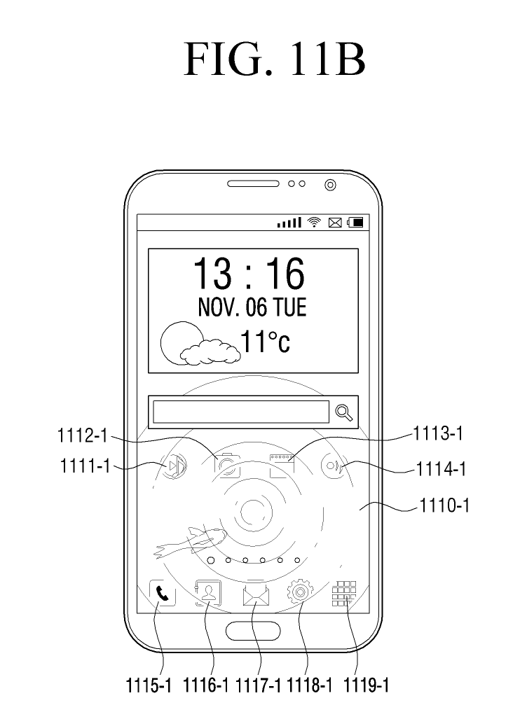

Specifically, when the user command for shaking of the display device 200 is input when the water-related wallpaper 1110 and first to ninth icons 1111 and 1119 are displayed as illustrated in FIG. 11A, as illustrated in FIG. 11B, the controller 270 may sense the user command indicating shaking of the display device 200 through the sensor unit 220 and control the display unit 230 to provide the visual effect that the entire wallpaper and the first to ninth icons 1111 to 1119 are shaking along with waves.

The visual effect provided according to the user command indicating shaking of the display device 200 in the water-related wallpaper 1110, as illustrated in FIGS. 11A and 11B, is merely exemplary and another visual effect may be provided for other wallpapers. For example, a visual effect may be provided in which the sand of the wallpaper is dispersed and scattered onto the icons in the sand-related desert wallpaper according to the user command for shaking of the display device 200. In yet another example, a visual effect may be provided in which snow is falling and covers the icon in the snow-related wallpaper according to the user command for shaking of the display device 200.

Further, the controller 270 may provide different visual effects according to a shaking degree and a shaking number of the display device 200. For example, when the snow-related wallpaper is displayed, the controller 270 may control the display unit 230 to provide a visual effect in which the snow is falling heavily as the shaking intensity of the display device 200 is increased and the number of times of shaking of the display device 200 is increased.

When a user blows on the display device 200 when a wallpaper and at least one icon are displayed in the display unit 230, the controller 270 may sense a user command for blowing based on the wind blowing at the display device 200 from the user through the sensor unit 220 and control the display unit 230 to provide a visual effect for the at least one icon in conjunction with the wallpaper according to a kind of wallpaper.

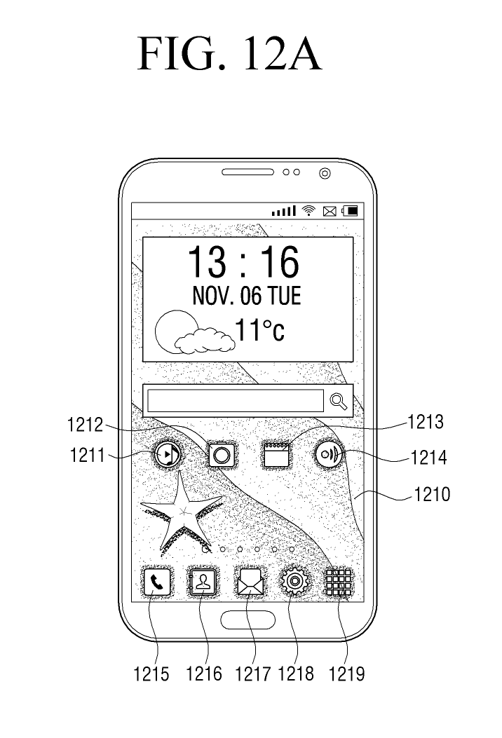

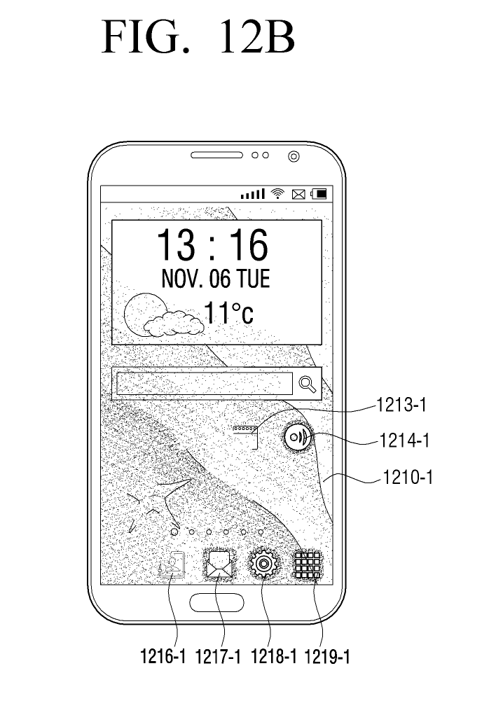

Specifically, when a user command for blowing at the display device 200 is input while the sand-related wallpaper 1210 and first to ninth icons 1211 and 1219 are displayed as illustrated in FIG. 12A, the controller 270 may sense the user command for blowing at the display device 200 through the sensor unit 220 and control the display unit 230 to provide a visual effect in which the sand of the wallpaper is sprinkled on the first to ninth icons 1211 to 1219 so that some of the icons disappear and others of the icons are buried in the sand as illustrated in FIG. 12B. When a preset period of time elapses, the controller 280 may control the display unit 230 to return to the wallpaper illustrated in FIG. 12A again.

The visual effect provided according to the user command for blowing at the display device 200 in the sand-related desert wallpaper 1210, as illustrated in FIGS. 12A and 12B, is merely exemplary and another visual effect may be provided to other wallpaper. For example, a visual effect may be provided in which waves are displayed in the water-related wallpaper according to the user command for blowing at the display device 200 and the icons may be displayed as rolling along the waves. In yet another example, a visual effect may be provided in the snow-related wallpaper in which snow of the wallpaper is sprinkled according to the user command for blowing at the display device 200 so that some of the icons disappear and others of the icons are covered with the snow.

When a user command for pinching two icons by the user is input while a wallpaper and at least one icon are displayed by the display unit 230, the controller 270 may control the display unit 230 to provide a visual effect in which the two icons pinch each other to affect an element of the wallpaper.

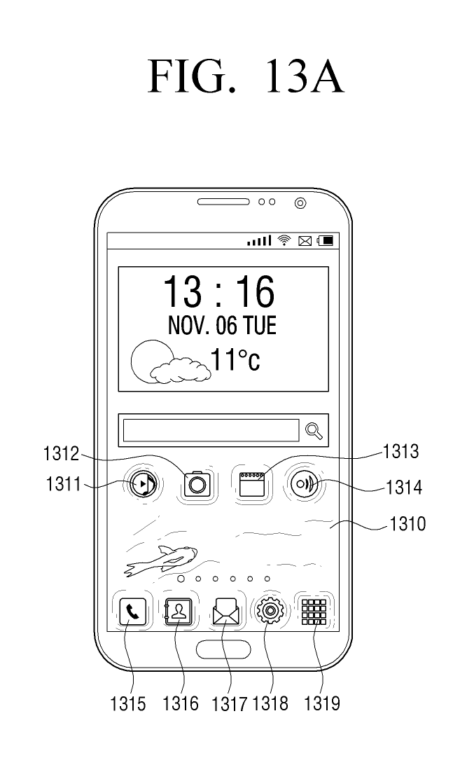

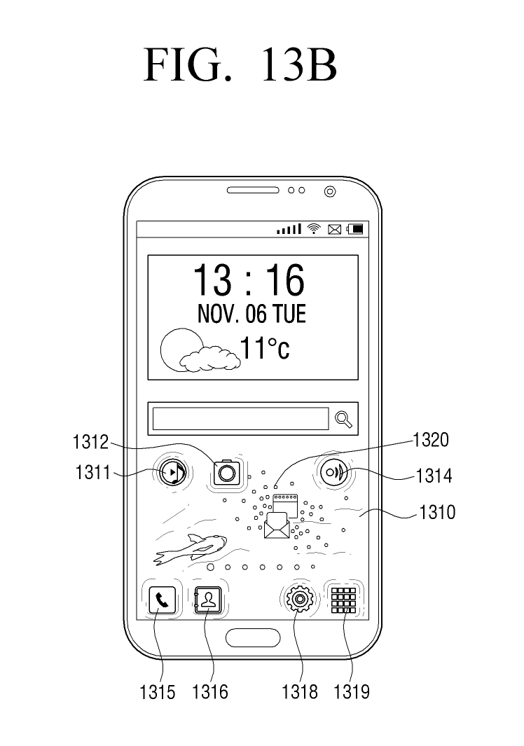

Specifically, for example, when a user command for pinching a third icon 1313 and a seventh icon 1317 is input while the water-related wallpaper 1310 and first to ninth icons 1311 and 1319 are displayed as illustrated in FIG. 13A, the controller 270 may control the display unit 230 to provide the visual effect that water drops occur at a point where the two icons 1313 and 1317 are pinched as illustrated in FIG. 13B.

The visual effect provided according to the user command for pinching the display device 200 in the water-related wallpaper 1310, as illustrated in FIGS. 13A and 13B, is merely exemplary and other visual effects may be provided to other wallpaper. For example, a visual effect may be provided in which the sand is sprinkled in a region at which the user command for pinching is input according to the user command for pinching in the sand-related desert wallpaper. In yet another example, a visual effect may be provided in which snow is sprinkled in a region at which the user command for pinching is input according to the user command for pinching, in the snow-related wallpaper.

When a user command for tilting or shaking the display device 200 is input while a wallpaper and at least one icon are displayed in the display unit 230, the controller 270 may control the display unit 230 to provide a visual effect that an element of the wallpaper affects the at least one icon of the wallpaper.

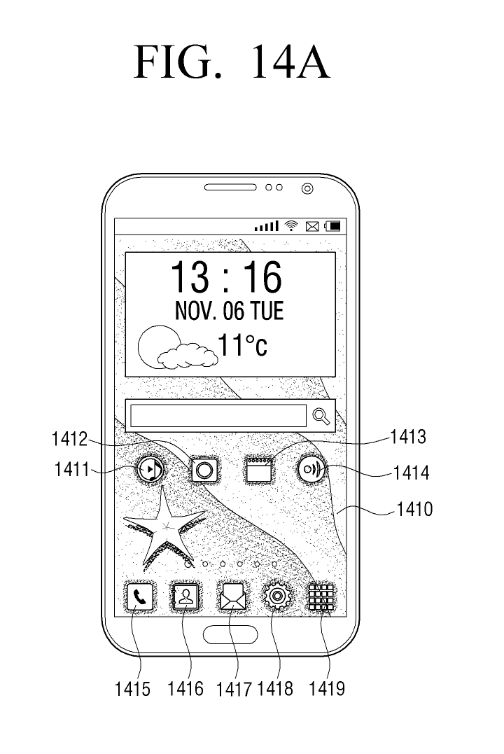

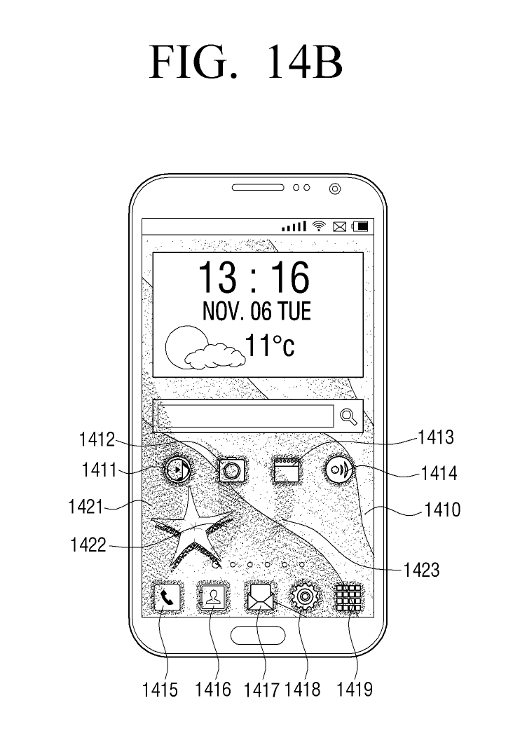

Specifically, when a user command for tilting the display device 200 to the left is input while the sand-related desert wallpaper 1410 and first to ninth icons 1411 and 1419 are displayed as illustrated in FIG. 14A, the controller 270 may sense tilting of the display device 200 and control the display unit 230 to provide the visual effect that a plurality of sandstorms 1421, 1422 and 1423 are blowing in a left region of the wallpaper and thus at least one icon of the icons may be displayed as being covered with sand, as illustrated in FIG. 14B.

The visual effect provided according to the user command for tilting or shaking the display device 200 in the sand-related desert wallpaper 1310, as illustrated in FIGS. 14A and 14B, is merely exemplary and other visual effects may be provided to other wallpaper. For example, a visual effect may be provided in which water is spilling or swaying according to the user command for tilting or shaking the display device 200 in the water-related wallpaper. In yet another example, a visual effect may be provided in which snow is fluttering according to the user command for tilting or shaking the display device in the snow-related wallpaper.

When a preset user command is input while a lock-mode release screen is displayed, the controller 270 may control the display unit 230 to provide a user visual for lock-mode release.

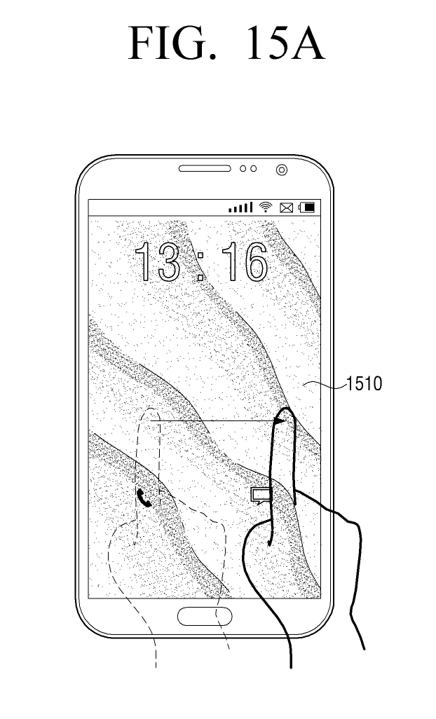

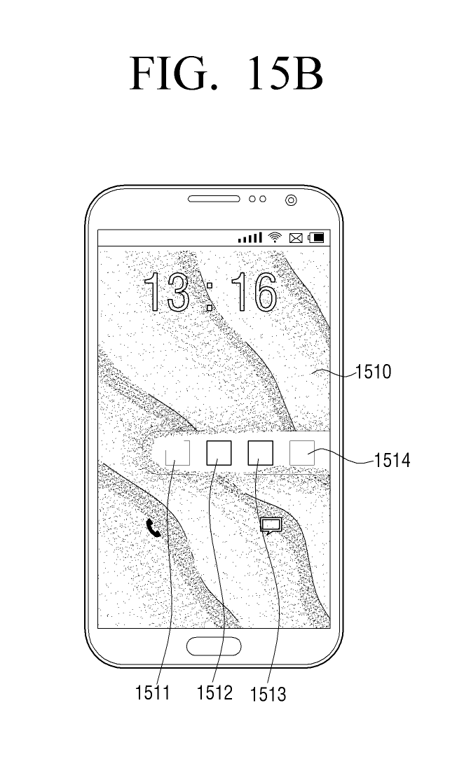

Specifically, for example, as illustrated in FIG. 15A, when a user command for dragging a specific region is input in a sand-related lock-mode release screen, the controller 270 may control the display unit 230 to display four icons 1511, 1512, 1513, and 1514 for password input for the lock-mode release while the sand existing in the dragged region is removed, as illustrated in FIG. 15B.

The visual effect according to the user command for releasing the lock mode in the sand-related lock-mode release screen as illustrated in FIGS. 15A and 15B is merely exemplary and other visual effects may be provided to other wallpaper. For example, a visual effect for a specific water stream for guiding a user touch for lock-mode release may be provided in water-related wallpaper. As another example, a visual effect for footprints for guiding a user touch for lock-mode release may be provided in a snow-related wallpaper.

When a user command is input while maintaining a standby mode, the controller 270 may control the display unit 230 to provide a visual effect and to display a lock-mode release screen.

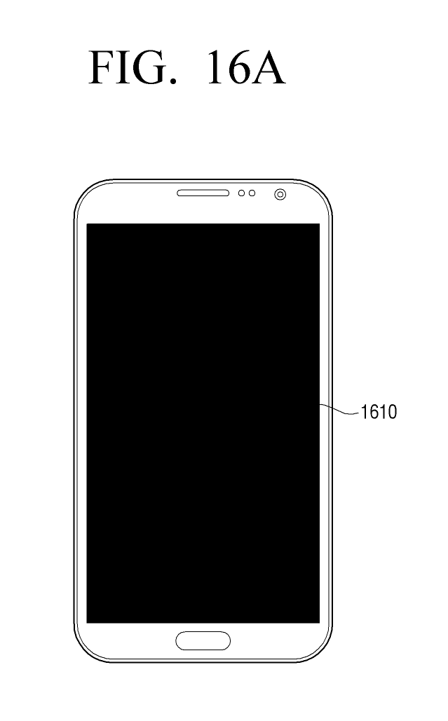

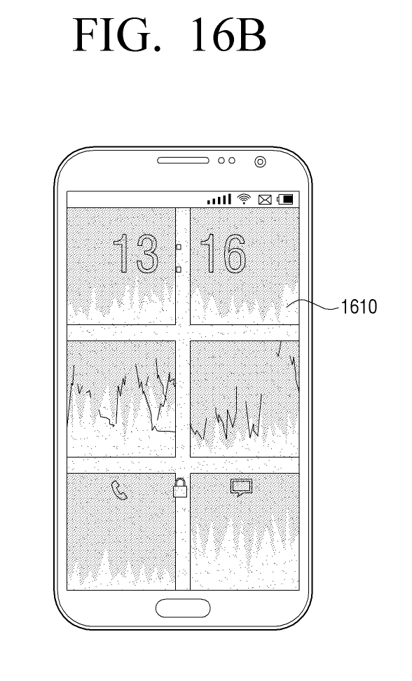

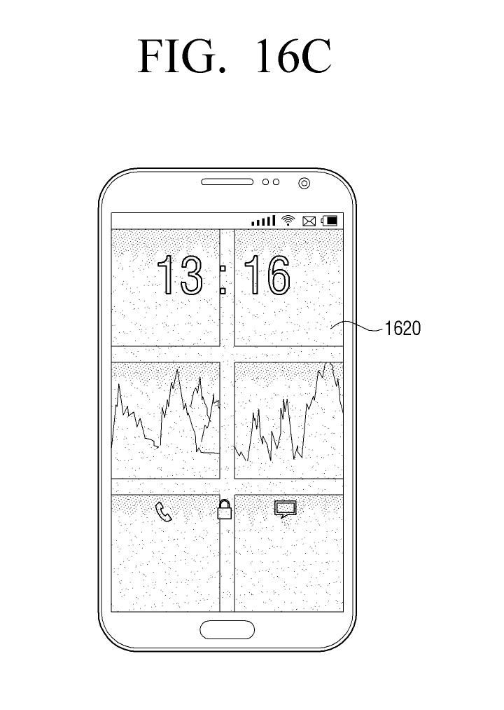

Specifically, while maintaining the standby mode, the display device 200 displays a black screen 1600 as illustrated in FIG. 16A. When a preset user command (for example, a command in which an external home button is selected) is input, the controller 270 may control the display unit to display a frosty lock-mode release screen 1610 as illustrated in FIG. 16B and the controller 270 may control the display unit 230 to provide a visual effect in which, as time passes, the frost is melted and thus a sharp lock-mode release screen 1620 is displayed.

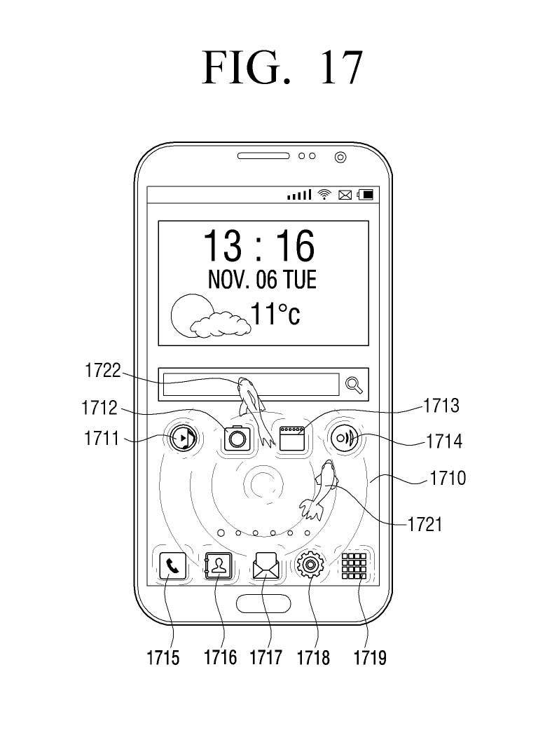

When the display unit 230 displays dynamic wallpaper, the controller 270 may control the display unit 230 so that an element moving in the dynamic wallpaper moves in a region other than a region in which at least one icon is displayed. For example, as illustrated in FIG. 17, when a dynamic wallpaper 1710 in which fishes 1721 and 1722 move is displayed, the controller 270 may control the display unit 230 so that the fishes 1721 and 1722 do not prevent the display of first to ninth icons 1711 to 1719 and move in the regions other than the regions in which the first to ninth icons 211 to 219 are displayed.

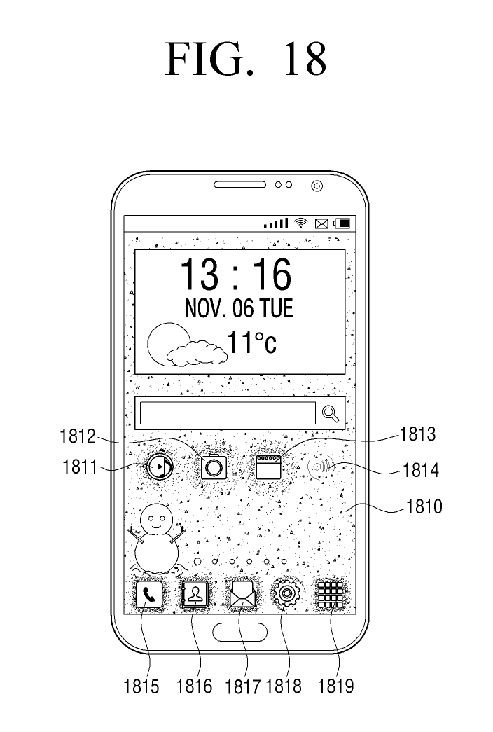

Further, the controller 270 may control the display unit 230 to display at least one of the icons in conjunction with the wallpaper differently from a manner in which the remaining icons of the icons are displayed according to an attribute of the at least one icon. For example, the attribute of the icon may include execution/non-execution of a program or application corresponding to the icon, a frequency of use of the icon, and the like. For example, when a snow-related wallpaper 1810 and a plurality of icons 1811 to 1819 are displayed as illustrated in FIG. 18, if the frequency of use of the fourth icon 1814 corresponding to a communication setting application among the plurality of icons 1811 to 1819 is low, the controller 270 may control the display unit 230 to be displayed as being deeper in the snow than the other icons.

Through provision of the above-described various visual effects, the user may be enabled to experience more interactive and entertaining user environments.

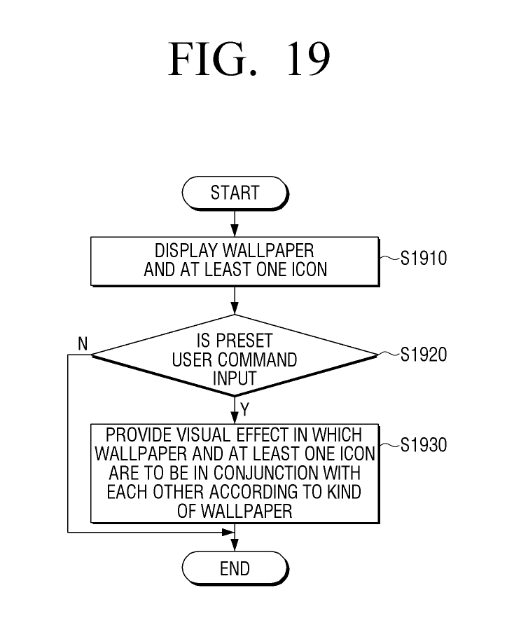

Hereinafter, a method for providing a UI of the display device 100 according to an exemplary embodiment is described with reference to FIG. 19.

The display device 100 displays wallpaper and at least one icon at operation S1910. The wallpaper may be static wallpaper, but is not limited thereto. Alternatively, the wallpaper may be dynamic wallpaper in which an element moves. Further, the at least one icon may be displayed on the same visual layer as the wallpaper.

Subsequently, the display device 100 determines whether or not a preset user command is input at operation S1920. The user command may include user commands for selecting, deleting, or moving the icon or a user command for turning a page of the wallpaper.

When the preset user command is input (operation S1920—Y), the display device 200 provides a visual effect in which the wallpaper is displayed in conjunction with the at least one icon according to a kind of wallpaper at operation S1930. Specifically, the display device 100 may provide the visual effects described with reference to FIGS. 5A to 18 according to the kind of wallpaper or a kind of user command.

Through the above-described method for providing a UI, the user may be enabled to experience more interactive and entertaining user environments.

In the above-described exemplary embodiments, the water-related wallpaper, the sand-related desert wallpaper, and the snow-related wallpaper have been illustrated as kinds of the wallpaper, but these kinds of wallpaper are exemplary only and other kinds of wallpaper may also be used according to exemplary embodiments.

The method of providing a UI of a display device according to the various exemplary embodiments may be implemented with a program and provided to a display apparatus.

Specifically, there may be provided a non-transitory computer readable medium in which a program is stored, the program enabling a technique including the operations of displaying wallpaper and at least one icon, and providing a visual effect in which the wallpaper and the at least one icon are displayed in conjunction with each other according to a kind of wallpaper when a preset user command is input.

According to an exemplary embodiment, the non-transitory computer-recordable medium may not be a medium configured to temporarily store data such as a register, a cache, or a memory, but instead may be an apparatus-readable medium configured to semi-permanently store data. Specifically, the above-described applications or programs may be stored and provided in a non-transitory computer-recordable medium such as a compact disc (CD), a digital versatile disc (DVD), a hard disc (HD), a blu-ray disc, a USB, a memory card, or a read only memory (ROM).

The foregoing exemplary embodiments and advantages are merely exemplary and are not to be construed as limiting the exemplary embodiments. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A method for providing a user interface (UI) of a display device, the method comprising:
displaying wallpaper and at least one icon; and
providing a visual effect in which the wallpaper and the at least one icon are displayed in conjunction with each other according to a kind of the wallpaper in response to a user command being input to the display device.

2. The method as claimed in claim 1, wherein, when the user command to select one of the at least one icon is input, the providing comprises providing the visual effect for the selected one of the at least one icon in conjunction with the wallpaper according to the kind of wallpaper, and
the method further comprises executing an application corresponding to the selected one of the at least one icon.

3. The method as claimed in claim 2, wherein, when the wallpaper comprises sand-related wallpaper, the providing comprises providing the visual effect in which the selected at least one icon is displayed as being sucked into sand.

4. The method as claimed in claim 2, wherein, when the wallpaper comprises water-related wallpaper, the providing comprises providing the visual effect in which the selected at least one icon is displayed as being soaked by water or disappearing into water.

5. The method as claimed in claim 2, wherein, when the wallpaper comprises snow-related wallpaper, the providing comprises generating an image of a footprint in a snowy road at a location in which the selected icon is displayed and providing the visual effect in which the selected icon is displayed as being positioned in the footprint.

6. The method as claimed in claim 1, wherein, when the user command to select and delete one of the at least one icons is input, the providing comprises:
providing the visual effect for the selected icon in conjunction with the wallpaper according to the kind of wallpaper; and
deleting the selected icon from a display screen.

7. The method as claimed in claim 1, wherein, when the user command for turning a page of the wallpaper is input, the providing comprises providing the visual effect in which an element of the wallpaper positioned at a location at which the user command is input is displayed in conjunction with the at least one icon according to the kind of wallpaper.

8. The method as claimed in claim 1, wherein the displaying comprises displaying the wallpaper and the at least one icon in a same visual layer.

9. The method as claimed in claim 1, wherein the wallpaper comprises dynamic wallpaper, and
wherein the displaying comprises displaying the at least one icon in conjunction with a motion of the dynamic wallpaper.

10. The method as claimed in claim 9, wherein the displaying comprises displaying an element moving in the dynamic wallpaper in a region other than a region in which the at least one icon is displayed.

11. The method as claimed in claim 1, wherein the displaying comprises displaying the at least one icon in conjunction with the wallpaper in a manner which is different from a manner of displaying remaining icons other than the at least one icon according to an attribute of the at least one icon.

12. A display apparatus, comprising:
a display configured to display wallpaper and at least one icon;
an inputter configured to receive a user command as input; and
a controller configured to control the display to provide a visual effect in which the wallpaper and the at least one icon are displayed in conjunction with each other according to a kind of wallpaper in response to the user command being input through the inputter.

13. The display apparatus as claimed in claim 12, wherein, when the user command to select one of the at least one icons is input through the inputter, the controller is configured to control the display to provide the visual effect for the selected one of the at least one icon in conjunction with the wallpaper according to the kind of wallpaper and is configured to execute an application corresponding to the one of the at least one selected icon.

14. The display apparatus as claimed in claim 13, wherein the display unit is configured to display sand-related wallpaper as the wallpaper, and
wherein the controller is configured to control the display to provide the visual effect in which the selected icon is displayed as being sucked into the sand.

15. The display apparatus as claimed in claim 13, wherein the display is configured to display water-related wallpaper as the wallpaper, and
wherein the controller is configured to control the display to provide the visual effect in which the selected one of the at least one icon is displayed as disappearing into the water.

16. The display apparatus as claimed in claim 13, wherein the display is configured to display snow-related wallpaper as the wallpaper,
wherein the controller is configured to generate an image of a footprint in a snowy road at a location in which the selected one of the at least one icon is displayed, and is configured to control the display to provide the visual effect in which the selected one of the at least one icon is positioned in the footprint.

17. The display apparatus as claimed in claim 12, wherein, when the user command to select and delete one of the at least one icon is input through the inputter, the controller is configured to control the display to provide the visual effect for the selected icon in conjunction with the wallpaper according to the kind of wallpaper and is further configured to delete the selected one of the at least one icon from a screen of the display.

18. The display apparatus as claimed in claim 12, wherein, when the user command for turning a page of the wallpaper is input through the inputter, the controller is configured to control the display to provide the visual effect in which an element of the wallpaper positioned at a location at which the user command is input is displayed in conjunction with the at least one icon according to the kind of wallpaper.

19. The display apparatus as claimed in claim 12, wherein the display is configured to display the wallpaper and the at least one icon in a same visual layer.

20. The display apparatus as claimed in claim 12, wherein the wallpaper comprises dynamic wallpaper, and
wherein the controller is configured to control the display to display the at least one icon in conjunction with a motion of the dynamic wallpaper.

21. The display apparatus as claimed in claim 20, wherein the controller is configured to control the display so that an element which is displayed as moving in the dynamic wallpaper moves in a region other than a region in which the at least one icon is displayed.

22. The display apparatus as claimed in claim 12, wherein the controller is configured to control the display so that the at least one icon is displayed in conjunction with the wallpaper in a manner which is different from a manner of displaying remaining icons other than the at least one icon according to an attribute of the at least one icon.

23. A mobile device, comprising:
a display configured to display wallpaper and an icon;
a sensor configured to sense a state of movement of the mobile device; and
a controller configured to control the display to display the icon and the wallpaper in a state of interaction with each other according to a kind of the wallpaper and the sensed state of movement.

24. The mobile device as claimed in claim 23, wherein the sensor comprises at least one from among a geomagnetic sensor configured to sense a rotation state and a moving direction of the mobile device and an acceleration sensor configured to sense a tilting degree of the mobile device.

25. The mobile device as claimed in claim 23, wherein the kind of the wallpaper comprises sand-related wallpaper, and the controller is configured to control the display to display a sandstorm blowing sand on the icon according to the sensed state of movement.

26. The mobile device as claimed in claim 23, wherein the kind of the wallpaper comprises water-related wallpaper, and the controller is configured to control the display to display water drops falling on the icon according to the sensed state of movement.

27. The mobile device as claimed in claim 23, wherein the kind of the wallpaper comprises snow-related wallpaper, and the controller is configured to control the display to display snowflakes falling on the icon according to the sensed state of movement.
